(19) United States
(12) Patent Application Publication
(10) Pub. No.: US 2008/0048051 A1
(43) Pub. Date: Feb. 28, 2008

(54) Misting Umberlla

(76) Inventor: Hung-Jen Chang, Taichung (TW)

Correspondence Address: HDSL, 4331 STEVENS BATTLE LANE, FAIRFAX, VA, 22033, US

(21) Appl. No.: 11/467,538

(22) Filed: Aug. 25, 2006

(51) Int. Cl. B05B 15/00

(52) U.S. Cl. 239/289; 239/373

(57) ABSTRACT

An exemplary misting umbrella includes an umbrella having an umbrella shank having a middle-empty structure, a plurality of umbrella ribs having an irradiation shape that disposed at a top end of the umbrella shank, an umbrella canopy covered the umbrella ribs, a pipe disposed in the umbrella shank, a nozzle disposed at an export of the pipe, and a joint disposed at one end of the umbrella shank that far away from the nozzle; an hydraulic pressure unit that using high pressure to transport gas or mist to the pipe of the umbrella and to spray out of the nozzle; and a switching valve for controlling the transporting of the gas or mist.

### BACKGROUND

The present invention relates to umbrellas, and more particularly to a misting umbrella conveniently in operation, and continuously spraying gas or mist.

Under the influence of greenhouse effect, the temperature of the summer is becoming higher. Therefore, a large cap having a wider brim or an umbrella is needed for reducing the irradiation of the sun light when people have outdoor action, such as walking, playing golf, or fishing. However, the efficiency of providing shelter is limited due to the increasing temperature of the circumstance adjacent to the umbrella or the cap. After a period of time of using the cap or umbrella, people will still feel discomfort due to higher temperature.

That is, if the conventional umbrellas could employ cooling equipment, the people using it will feel nice and cool, and then the efficiency of providing shelter is improved. However, all the conventional umbrellas do not suggest to adding a cooling equipment thereto, the efficiency of providing shelter is still lower.

Accordingly, what is needed is a misting umbrella that can overcome the above-described deficiencies.

### BRIEF SUMMARY

Accordingly, an object of the present invention is to provide a misting umbrella, which is functioned as spraying gas or mist.

Another object of the present invention is to provide a misting umbrella, which is easily and conveniently to operation.

An exemplary misting umbrella includes an umbrella having an umbrella shank having a middle-empty structure, a plurality of umbrella ribs having an irradiation that disposed at a top end of the umbrella a shank, an umbrella canopy covered the umbrella ribs, a pipe disposed in the umbrella shank, a nozzle disposed at an export of the pipe, and a joint disposed at one end of the umbrella shank that far away from the nozzle; an hydraulic pressure unit that using high pressure to transport gas or mist to the pipe of the umbrella and to spray out of the nozzle; and a switching valve for controlling the transporting of the gas or mist.

With these configurations, the misting umbrella may spray gas or mist via the nozzle that providing by the hydraulic pressure unit, and the gas or mist are evenly sprayed to the region around the head of the user, so as to cool the user and decrease the temperature around the user.

Other advantages and novel features will become more apparent from the following detailed description when taken in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic, exploded view of a misting umbrella according to a first embodiment of the present invention, showing states of all individual elements;

FIG. 2 is a schematic, assembly view of the misting umbrella of FIG. 1;

FIG. 3 is a schematic view of the misting umbrella of FIG. 1, showing the misting umbrella in an operation state;

FIG. 4 is a schematic view of part of a misting umbrella according to a second embodiment of the present invention;

FIG. 5 is a schematic view of a misting umbrella according to a third embodiment of the present invention, showing the misting umbrella in an operation state;

FIG. 6 is a schematic, exploded view of a misting umbrella according to a fourth embodiment of the present invention;

FIG. 7 is a schematic, exploded view of a misting umbrella according to a fifth embodiment of the present invention;

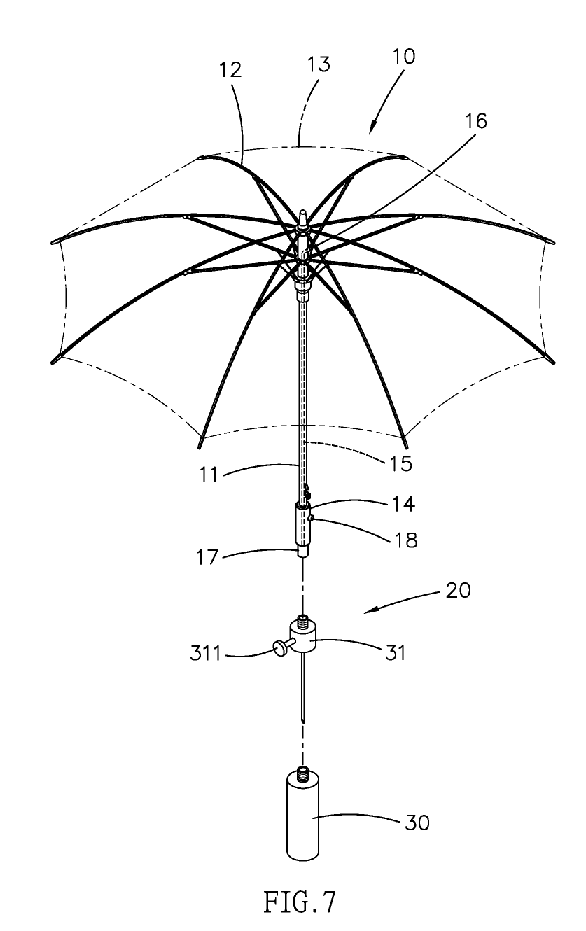

FIG. 8 is a schematic, side view of a misting umbrella according to a sixth embodiment of the present invention; and

FIG. 9 is a schematic, side view of a misting umbrella according to a seventh embodiment of the present invention.

### DETAILED DESCRIPTION

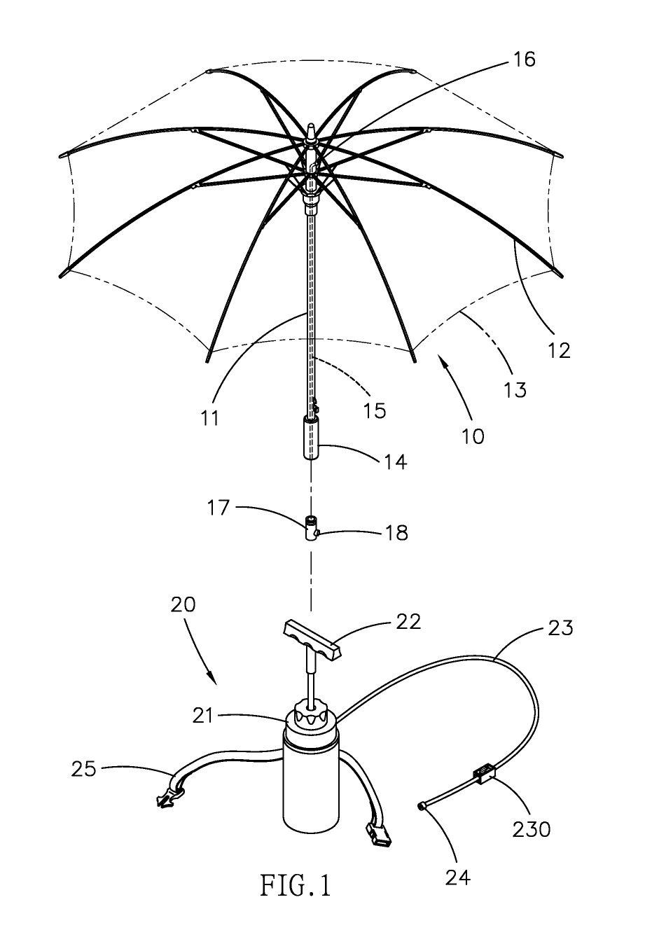

Referring to FIG. 1, a misting umbrella according to a first embodiment of the present invention is shown. The misting umbrella includes an umbrella 10 and a hydraulic pressure unit 20, whereby the hydraulic pressure unit 20 may transport gas or mist to the umbrella 10 and spray the gas or mist inside or outside the umbrella 10. The gas or mist may be vapour, astringent, perfume, oxygen or the combinations thereof.

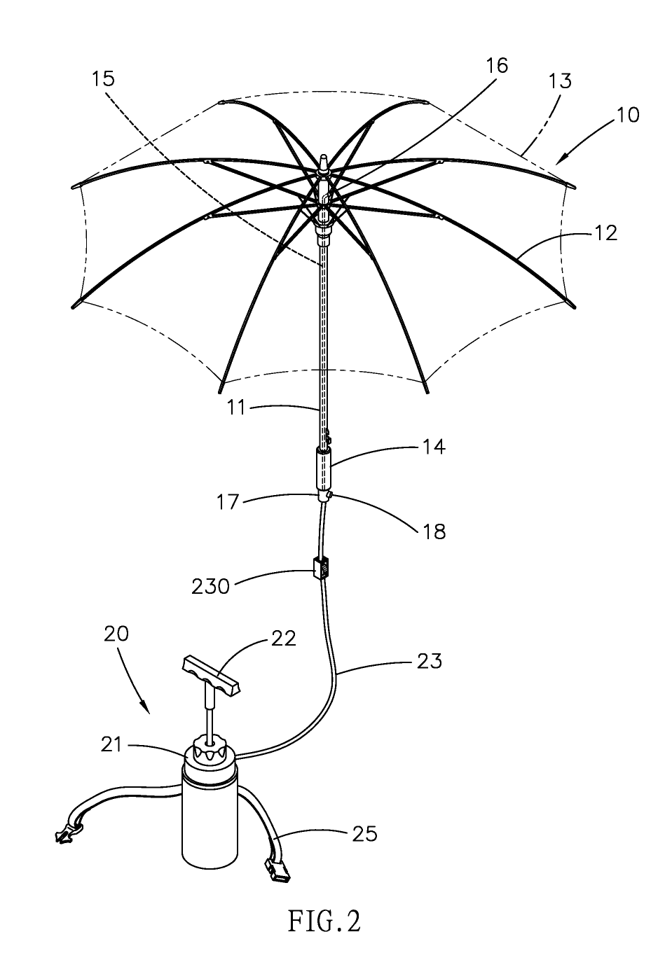

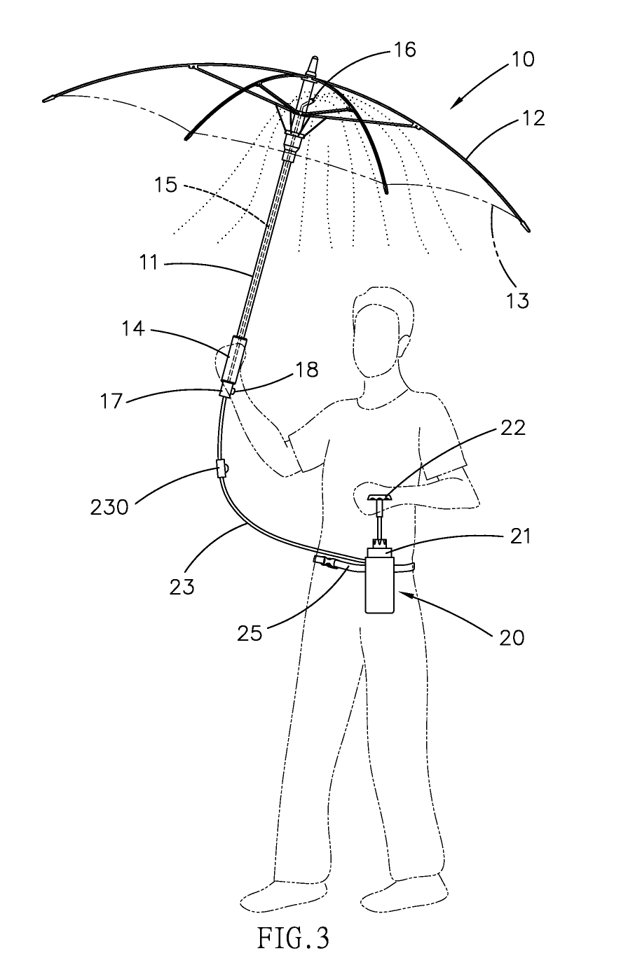

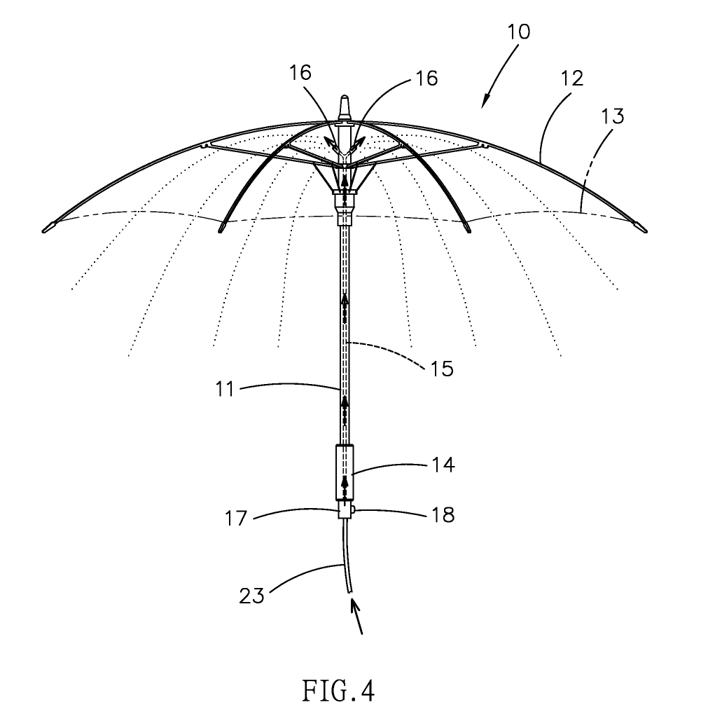

Further referring to FIGS. 2 and 3, the umbrella 10 includes an umbrella shank 11 having a middle-empty structure, a plurality of umbrella ribs 12 having an irradiation shape that are disposed at the top end of the umbrella shank 11, and an umbrella canopy 13 cover the umbrella ribs 12. The umbrella ribs 12 include a plurality of collapsible umbrella ribs and un-collapsible ribs, and the umbrella canopy 13 can is waterproof. The umbrella shank 11, the umbrella ribs 12, and the umbrella canopy 13 cooperatively to form the umbrella 10 functioned as sun sheltering and waterproofed. A handle 14 is disposed at a bottom end of the umbrella shank 11, and a pipe 15 is pronged through the middle portion of the umbrella shank 11. The pipe 15 may flex with the umbrella shank 11, which includes at least one nozzle 16 disposed at export thereof. The pipe 15 may includes a plurality of nozzles, for example, three nozzles that are shown in FIG. 4. The nozzle 16 may spray in many different directions, such as upwards, downwards or flatly, and the nozzle 16 may disposed at any position of the umbrella shank 11 that between the handle 14 and the top end of the umbrella shank 11 that outside the umbrella canopy 13. A joint 17 is disposed at one end of the umbrella shank 11 that far away from the nozzle 16, such as the bottom end of the handle 14, and a switching valve 18 is disposed adjacent to the joint 17. The switching valve 18 may also disposed at a position of one of the umbrella shank 11, the handle 14, the transport pipe 23, and the hydraulic pressure unit 20.

Also referring to FIG. 4, the hydraulic pressure unit 20 use high pressure to transport gas or mist to the nozzle 16 of the umbrella 10, which includes a high pressure reservoir 21 containing gas or liquid. The reservoir 21 includes a pressure adding pole 22, and a transport pipe 23 having an adjusting valve 230 to control the flux of the gas or liquid. A sleeve 24 is disposed at one end of the transport pipe 23, which is mating with the joint 17 of the umbrella 10. With this configuration, the user may rapidly assemble or dissemble the umbrella 10 and the hydraulic pressure unit 20. Moreover, a loincloth 25 is disposed at the hydraulic pressure unit 20, which enable the user to bind the hydraulic pressure unit 20 at the waist. Therefore, the misting umbrella with the loincloth 25 is portable.

The misting umbrella use high pressure to transport gas or mist to the nozzle 16 of the umbrella 10, and spray gas or mist to the user for decreasing the temperature or providing oxygen. At the same time, the misting umbrella is portable.

In operation, still referring to FIGS. 2 and 3, the user can bind the high pressure reservoir 21 of the hydraulic pressure unit 20 at the waist to conveniently catch it, then quickly connect the joint 17 of the umbrella shank 11 of the umbrella 10 to the sleeve 24 of the transport pipe 23 of the high pressure reservoir 21. When the user press on the switching valve 18, the mist in the high pressure reservoir 21 is transported to the nozzle 16 via transport pipe 23 and the pipe 15, and then spray out. Meanwhile, the user may adjust flux of the mist via adjusting the valve 230. The misting umbrella is portable and conveniently operation, and the effect of sun sheltering and waterproofed are greatly improved.

Different gas or mist will bring different effect, such as water to decrease temperature, astringent to cool and keep wet, perfume and oxygen to refresh the user.

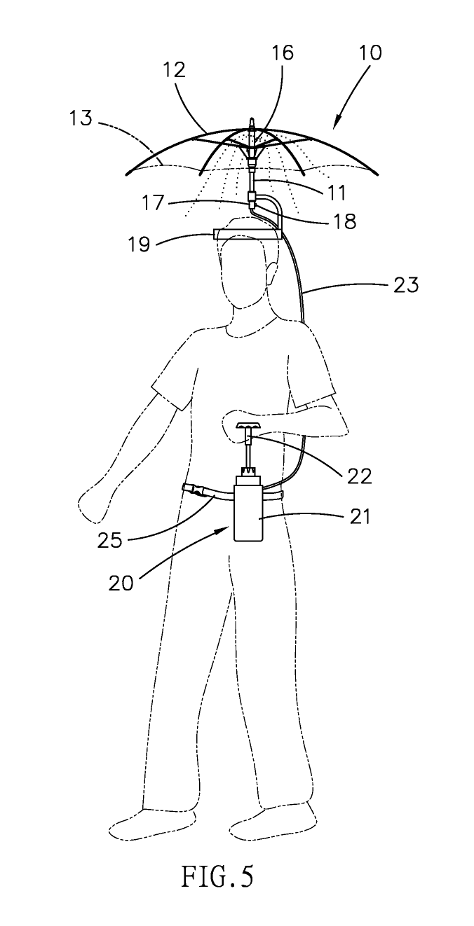

Referring to FIG. 5, a misting umbrella according to another embodiment is shown. Beside the joint 17, a ringer 19 is disposed at a bottom end of the umbrella shank 11, which make the user no need to handle the umbrella 10 with both hands. Therefore, this misting umbrella is more convenient.

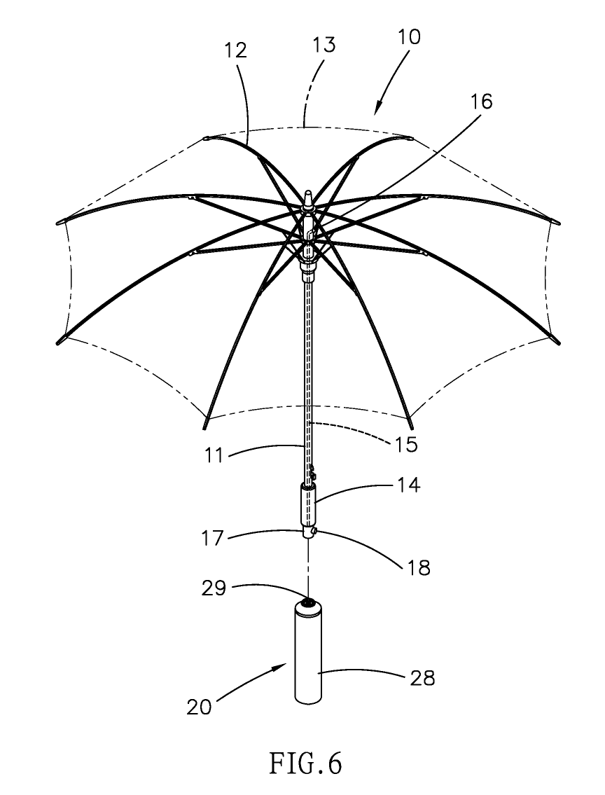

Referring to FIG. 6, a misting umbrella according to further another embodiment is shown. The hydraulic pressure unit 20 is a high pressure jar 28 having high pressure supply, the high pressure jar 28 may fill in gas or liquid. The high pressure jar 28 further includes a spray head 29 that connecting to the joint 17 of the umbrella 10. The high pressure jar 28 may also employ a transport pipe to connect to the joint 17.

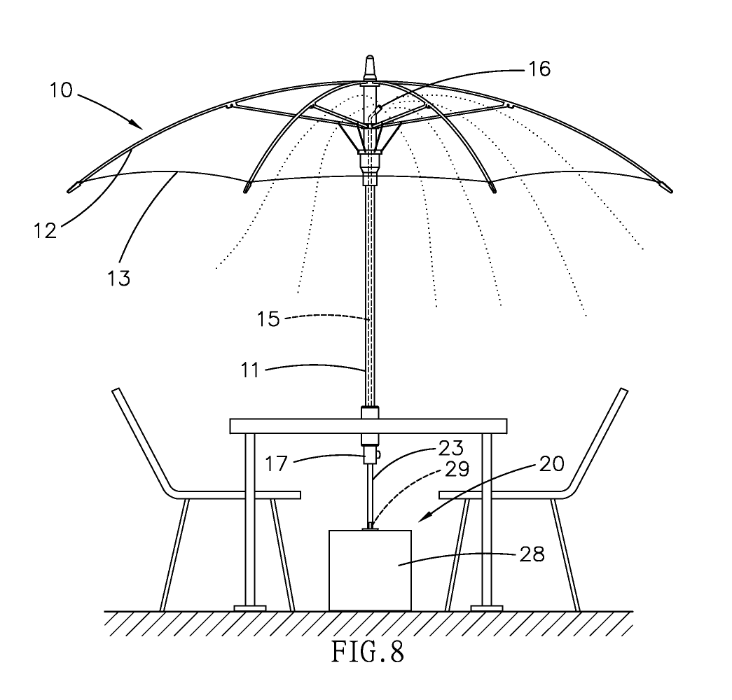

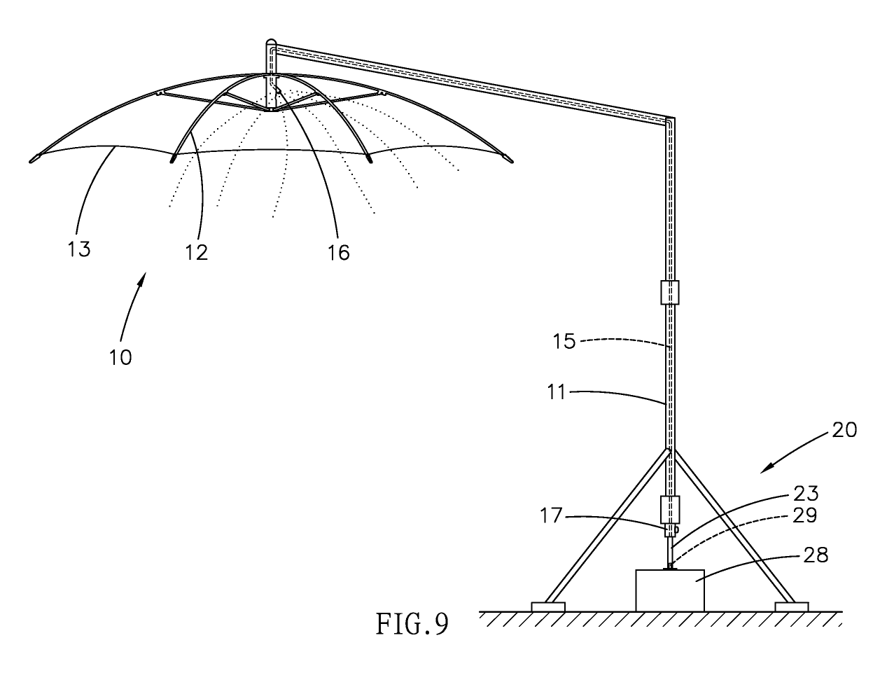

Referring to FIGS. 8 and 9, the umbrella shank 11 is disposed on a stand, which is convenient to use the misting umbrella in outdoor location, such as beach or swimming pool. In addition, the high pressure jar 28 may be a bigness container, and transport high pressure gas or mist to several umbrellas via transport pipes 23 at the same time.

Referring to FIG. 6, a misting umbrella according to further another embodiment is shown. The hydraulic pressure unit 20 includes a container 30 and a pump 31. The pump 31 includes a pressure adding pole 311. The pump 31 may transport the liquid containing in the container 30 to the nozzle 16 via the pipe 15 and spray out of the nozzle 16.

According to above-described, the joint 17 may be a quickly detaching joint, which make this invention more convenient. Furthermore, the joint 17 includes screw thread, which make the connection of the joint more facility.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A misting umbrella, comprising:
an umbrella comprising an umbrella shank having a middle-empty structure, a plurality of umbrella ribs having an irradiation shape that being disposed at a top end of the umbrella shank, an umbrella canopy covering the umbrella ribs, a pipe disposed in the umbrella shank, a nozzle disposed at an export of the pipe, and a joint disposed at one end of the umbrella shank that far away from the nozzle;
an hydraulic pressure unit that using high pressure to transport gas or mist to the pipe of the umbrella and to spray out of the nozzle; and
a switching valve for controlling the transporting of the gas or mist.

2. The misting umbrella as claimed in claim 1, wherein the umbrella shank comprises flexible structure, and the pipe being flexed with the umbrella shank.

3. The misting umbrella as claimed in claim 1, wherein the nozzle spray in different directions, such as upwards, downwards or flatly.

4. The misting umbrella as claimed in claim 1, wherein the switching valve is disposed at a position of one of the umbrella shank, a handle of the umbrella shank, and the hydraulic pressure unit.

5. The misting umbrella as claimed in claim 1, wherein the hydraulic pressure unit is a high pressure reservoir containing gas or liquid, the reservoir comprises a pressure adding pole and a transport pipe having a sleeve disposed at one end of the transport pipe that corresponding to the joint.

6. The misting umbrella as claimed in claim 5, wherein high pressure reservoir comprises a loincloth for binding the high pressure reservoir to a waist of the user.

7. The misting umbrella as claimed in claim 5, wherein the transport pipe comprises an adjusting valve for controlling the flux of the gas or liquid.

8. The misting umbrella as claimed in claim 1, further comprising a ringer disposed at a bottom end of the umbrella shank for wearing on a head of the user.

9. The misting umbrella as claimed in claim 1, wherein the hydraulic pressure unit is a high pressure jar having pressure supply, the high pressure jar includes a spray head that connecting to the joint of the umbrella.

10. The misting umbrella as claimed in claim 1, wherein the gas or mist contained in the hydraulic pressure unit is one of the vapour, astringent, perfume, oxygen and the combinations thereof.

11. The misting umbrella as claimed in claim 1, wherein the hydraulic pressure unit further comprises a container and a pump, the pump comprises a pressure adding pole, and the pump transport the liquid containing in the container to the nozzle via the pipe and spray the liquid out of the nozzle.

12. The misting umbrella as claimed in claim 1, wherein the umbrella shank is disposed on a stand.

13. The misting umbrella as claimed in claim 4, wherein the hydraulic pressure unit is a high pressure jar having high pressure supply, the high pressure jar includes a spray head that connecting to the joint of the umbrella.

14. The misting umbrella as claimed in claim 5, wherein the gas or mist contained in the hydraulic pressure unit is one of the vapour, astringent, perfume, oxygen and the combinations thereof.

15. The misting umbrella as claimed in claim 11, wherein the gas or mist contained in the hydraulic pressure unit is one of the vapour, astringent, perfume, oxygen and the combinations thereof.
